(19) United States
(12) Patent Application Publication
(10) Pub. No.: US 2025/0131207 A1
(43) Pub. Date: Apr. 24, 2025

(54) INFORMATION PROCESSING METHOD, ELECTRONIC DEVICE, AND STORAGE MEDIUM

(71) Applicant: Lenovo (Beijing) Limited, Beijing (CN)

(72) Inventors: Qiushi HAN, Beijing (CN); Xudong ZHANG, Beijing (CN); Xuemeng ZHAO, Beijing (CN)

(21) Appl. No.: 18/924,875

(22) Filed: Oct. 23, 2024

(30) Foreign Application Priority Data
Oct. 24, 2023 (CN) 202311388566.1

(51) Int. Cl. G06F 40/40

(52) U.S. Cl. CPC G06F 40/40

(57) ABSTRACT

An information processing method includes obtaining an input request of a user; based on a relationship between the input request and user information of the user, determining, from a target data source, at least first data in which the input request satisfies a relevant condition with the user information in a direction of the requested result, the target data source including data related to the user information; generating first prompt information based on the first data; and sending the input request and model prompt information to a target model for performing language processing on the input request based on the model prompt information and obtaining a feedback result corresponding to the input request in the direction of the requested result, the model prompt information including the first prompt information.

### CROSS-REFERENCE TO RELATED APPLICATION

This application claims priority to Chinese Patent Application No. 202311388566.1, filed on Oct. 24, 2023, the entire content of which is incorporated herein by reference.

### TECHNICAL FIELD

The present disclosure generally relates to the field of natural language processing and artificial intelligence technology and, more particularly, to an information processing method, an electronic device, and a storage medium.

### BACKGROUND

In the application field of the large language model (LLM), output data of the model is usually not customized enough. For example, in personalized question-answering scenarios, the model often finds it difficult to give customized answers to satisfy users. Therefore, how to improve the customization of the model output data, improve the processing effect of the model, and enable users to obtain satisfactory customized results has become a technical problem that needs to be solved.

### SUMMARY

One embodiment of the present disclosure provides an information processing method. The method includes obtaining an input request of a user; based on a relationship between the input request and user information of the user, determining, from a target data source, at least first data in which the input request satisfies a relevant condition with the user information in a direction of the requested result, the target data source including data related to the user information; generating first prompt information based on the first data; and sending the input request and model prompt information to a target model for performing language processing on the input request based on the model prompt information and obtaining a feedback result corresponding to the input request in the direction of the requested result, the model prompt information including the first prompt information.

Another embodiment of the present disclosure provides an electronic device. The electronic device includes one or more processors, and a memory containing a computer program that, when being executed, causes the one or more processors to perform: obtaining an input request of a user; based on a relationship between the input request and user information of the user, determining, from a target data source, at least first data in which the input request satisfies a relevant condition with the user information in a direction of the requested result, the target data source including data related to the user information; generating first prompt information based on the first data; and sending the input request and model prompt information to a target model, the target model performing language processing on the input request based on the model prompt information and obtaining a feedback result corresponding to the input request in the direction of the requested result. The model prompt information includes the first prompt information.

Another embodiment of the present disclosure provides a non-transitory computer readable storage medium containing a computer program that, when being executed, causes at least one processor to perform: obtaining an input request of a user; based on a relationship between the input request and user information of the user, determining, from a target data source, at least first data in which the input request satisfies a relevant condition with the user information in a direction of the requested result, the target data source including data related to the user information; generating first prompt information based on the first data; and sending the input request and model prompt information to a target model, the target model performing language processing on the input request based on the model prompt information and obtaining a feedback result corresponding to the input request in the direction of the requested result. The model prompt information includes the first prompt information.

### BRIEF DESCRIPTION OF THE DRAWINGS

FIG. 1 is a flowchart of an information processing method consistent with various embodiments of the present disclosure.

FIG. 2 is another flowchart of an information processing method consistent with various embodiments of the present disclosure.

FIG. 3 is another flowchart of an information processing method consistent with various embodiments of the present disclosure.

FIG. 4 is a processing flowchart of an application of an information processing method consistent with various embodiments of the present disclosure.

FIG. 5 is a schematic structural diagram of an information processing device consistent with various embodiments of the present disclosure.

FIG. 6 is a schematic structural diagram of an electronic device consistent with various embodiments of the present disclosure.

### DETAILED DESCRIPTION OF THE EMBODIMENTS

Specific embodiments of the present disclosure are hereinafter described with reference to the accompanying drawings. The described embodiments are merely examples of the present disclosure, which may be implemented in various ways. Specific structural and functional details described herein are not intended to limit, but merely serve as a basis for the claims and a representative basis for teaching one skilled in the art to variously employ the present disclosure in substantially any suitable detailed structure. Various modifications may be made to the embodiments of the present disclosure. Thus, the described embodiments should not be regarded as limiting, but are merely examples. Those skilled in the art will envision other modifications within the scope and spirit of the present disclosure.

The present disclosure provides an information processing method, an information processing device, an electronic device, and a non-transitory computer readable storage medium, to improve customization of output data of a target model such as a large language model, improve the model processing effect, and enable users to obtain more satisfactory customized results. The information processing method provided by various embodiments of the present disclosure may be applied to electronic devices in many general or special computing device environments or configurations, such as personal computers, server computers, handheld devices or portable devices, tablet devices, multi-processor devices, etc.

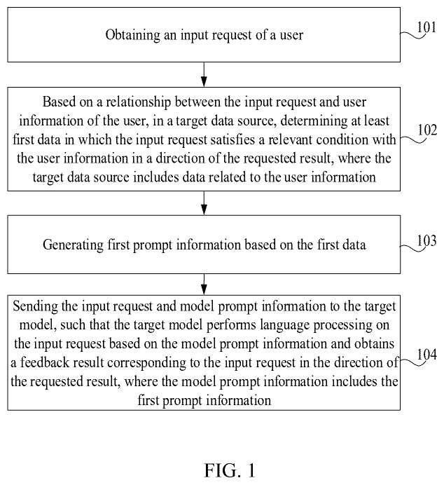

In one embodiment shown in FIG. 1 which is a flowchart of an information processing method provided by the present disclosure, the information processing method includes S101 to S104.

At S101, a user's input request is obtained.

Optionally, in one embodiment, the obtained input request may be a request for input into a target model, such as a large language model, for the target model to perform language processing.

The large language model may refer to a deep learning model trained with a large amount of text data, which may generate natural language text or understand the meaning of language text. The large language model may be able to handle a variety of natural language tasks, such as text classification, question and answer, dialogue, etc., and is an important path to artificial intelligence.

Taking a personalized question/answer scenario as an example, the input request may be a question raised by a user, which may specifically be, but is not limited to, a question raised by a user through manual entry or voice interaction.

A S102, based on a relationship between the input request and the user information of the user, at least first data in which the input request meets a relevant condition with respect to the user information in the direction of the requested result is determined in a target data source. The target data source may include multiple data related to the user information.

The user information may include but is not limited to the user's gender, age, nature of work, location area, preferences (such as favorite electronic products, preferred type, performance, configuration), etc. Optionally, the user information may be obtained by prompting the user to input and/or be obtained through other channels (such as collecting the user's registered information).

The target data source may be an existing first data source, or a first data source determined based on a second data source. In some other embodiments, the target data source may include both the existing first data source and the first data source determined based on the second data source. The second data source may be public domain data source formed by public domain data, and the first data source may be a non-public domain data source formed by multiple data related to the user information.

The existing first domain data source may be, but is not limited to, a user's personal domain data source or private domain data source. The personal domain data source may include, but is not limited to, a data source formed by the user's personal collection, historical transactions or other personal data. The private domain data source may be a data source formed by non-public domain data corresponding to a group or workgroup that may be shared only between users within a certain range, such as a data source formed by the user and his or her friends' collections, historical transactions or other data, or a data source formed by the shared data within the workgroup to which the user belongs.

The second data source may be a public domain data source, which may be, optionally, a data source formed by a data range that may be searched by various public search engines.

Optionally, in one embodiment, determining the first data source based on the second data source may include: using the input request in combination with the user information as a search condition, searching the second data source, and using the search result data as the first data source (i.e., the first data source determined based on the second data source).

For example, the original text data of the input request and user information may be directly used as the search condition, or the keywords of the input request and user information may be used as the search condition. The second data source may be searched through the corresponding search engine based on the semantic similarity, and multiple search result data (such as multiple documents, literature, news messages, etc.) may be obtained and used as the first data source determined based on the second data source.

In one embodiment, a first index data set may be constructed, and the first index data set may be a data set created based on the index data corresponding to each data in the user information and the target data source. Each index data may include keywords and/or semantic features of the corresponding user information, or include keywords and/or semantic features of the data corresponding to the target data source.

The first index data set may be constructed in real time or in advance. The present disclosure has no limit on this, which may be determined according to actual needs. For example, in one embodiment, when the user uses a personalized question-and-answer application or website based on a large language model for the first time, then for the first question (input request) input by the user to the model, the corresponding first index data set may be constructed in real time based on the user information and the target data source. For the questions input by the user later, the already constructed first index data set may be reused, and it may not be necessary to construct it in real time.

Optionally, the relationship between the user's input request and the user information may be a relationship between keywords of the input request and keywords of the user information, for example, may be that there is an overlap or no overlap between the keywords of the input request and the keywords of the user information.

At S102, the input request may be segmented and keyword extracted to obtain the keywords of the input request, and whether the keywords of the input request overlap with the keywords of the user information may be determined. When there is an overlap, the first index data set may be searched based on the overlapping keywords between the keywords of the input request and the keywords of the user information (referred to as “overlapping keywords”) to obtain the first search result data, and the first search result data may be determined as the first data that satisfies the relevant condition of the input request and the user information in the requested result direction. It is easy to understand that each piece of data in the first search result data (first data) may include data information of the corresponding piece of data in the target data source. Taking each piece of data in the target data source as a document as an example, it may include the corresponding document, or include a series of keywords and/or semantic features respectively contained in the corresponding document.

When determining whether the keywords of the input request and the keywords of the user information overlap, the keywords of the user information used may be obtained by performing real-time word segmentation or keyword extraction processing on the user information, or the user information keywords obtained in the first index data set construction stage may be reused.

In one embodiment, searching the first index data set based on the overlapping keywords between the input request and the user information to obtain the first search result data, may include: searching the first index data set based on the overlapping keywords and using each piece of obtained data that meets the keyword matching condition with the overlapping keywords directly as the first search result data.

In another embodiment, searching the first index data set based on the overlapping keywords between the input request and the user information to obtain the first search result data, may include that: the overlapping keywords are used as the search basis, and each piece of data that satisfies the keyword matching condition with the overlapping keywords and is searched from the first index data set is used as the intermediate search result data; on this basis, the semantic similarity between each piece of data in the intermediate search result data and the input request is further determined based on the semantic features of the input request and the semantic features of each piece of data in the intermediate search result data, and each piece of data in the intermediate search result data whose semantic similarity with the input request satisfies the semantic similarity condition is used as the first search result data.

For example, the semantic features of each piece of data in the intermediate search result data and the semantic features of the input request may be converted into feature vector forms respectively, and the semantic similarity between the semantic features of each piece of data in the intermediate search result data and the semantic features of the input request may be characterized by calculating the distance between the feature vectors corresponding to each piece of data in the intermediate search result data and the input request. The feature vector distance may be inversely correlated with the semantic similarity. When the feature vector distance is larger, the semantic similarity may be lower, and when the feature vector distance is smaller, the semantic similarity may be higher.

The keyword matching condition may include, but is not limited to, that the matching degree with the overlapping keywords reaches a preset matching degree value, or the matching degree with the overlapping keywords is the top N in the matching degree descending sequence. Similarly, the semantic matching condition may include, but is not limited to, the distance to the feature vector of the input request is less than the set distance value, or the distance to the feature vector of the input request is the top N in the distance (feature vector distance) ascending sequence. N may be an integer greater than or equal to 1.

The value of N in the above two conditions may be the same value or different values, without limitation. And the keyword matching conditions involved in the above two implementation methods of obtaining the first search result data may be the same or different, and are also not limited.

At S103, first prompt information is generated based on the first data.

In one embodiment, the first data may be directly used as the first prompt information. In some other embodiment, the first data may also be processed accordingly, and the processing result data may be used as the first prompt information. For example, the keywords in each data included in the first data may be processed by synonym merging or removing stop words, and each keyword retained after processing may be used as the first prompt information.

At S104, the input request and model prompt information are sent to the target model, such that the target model performs language processing on the input request based on the model prompt information, to obtain the feedback result corresponding to the input request in the requested result direction. The model prompt information includes the first prompt information.

After obtaining the first prompt information, the model prompt information may be further obtained based on the first prompt information, and the model prompt information may at least include the first prompt information. Subsequently, the user's input request and the model prompt information may be input into the target model, and the target model may perform language processing on the input request based on the model prompt information.

The first data may be data in the target data source that satisfies the relevant condition with the user information in the direction of the requested result in the input request. Since the first data satisfies the relevant condition with the user information, the first data may be used as the data of the points of interest in the target data source that the input request is interested in in the direction of the requested result. Therefore, the first prompt information generated based on the first data may be used as prompt information of the points of interest in the direction of the requested result in the input request, and may characterize the user's points of interest in the direction of the result requested by the input request, thereby prompting the user's points of interest to the target model. The prompted points of interest may be the user's points of interest in the direction of the result requested by the input request.

The target model may correspondingly perform language processing on the input request based at least on the first prompt information in the model prompt information, and obtain the feedback result corresponding to the input request in the direction of the requested result.

In one embodiment, the target model may obtain the various optional feedback results corresponding to the input request in the direction of the requested result by performing the required language processing on the input request, and, based at least on the user's points of interest prompted by the first prompt information in the model prompt information, screen out one or more feedback results corresponding to the user's points of interest from the various optional feedback results for output, such that the user may obtain a satisfactory customized result.

For example, in a personalized question-and-answer scenario, the large language model may generate answers to the questions input by the user to obtain various optional answers to the input questions, by performing answer generation processing. For example, multiple optional answers may be generated for the question input by the user, “What are the computers that meet the xx function?” On this basis, based on at least the user's points of interest represented by the first prompt information in the model prompt information, one or more answers corresponding to the user's points of interest may be screened out from the various optional answers and output. For example, from various computers that meet the xx function, one or more computers corresponding to the device size, model, processor model, etc. represented by the user's points of interest may be screened out (for example, they can be the same or close to the device size, model, processor model, etc. represented by the user's points of interest), and the screening result information may be output as the answer to the user's question, thereby obtaining the answer data of the user's question in the requested result direction, and the answer data may include the answer corresponding to the user's points of interest.

In the information processing method provided by the present disclosure, after obtaining the user's input request, based on the relationship between the input request and the user information, at least the first data in the target data source that satisfies the relevant condition with the user information in the direction of the requested result in the input request may be determined, and the first prompt information may be generated based on the first data. The model prompt information including the first prompt information may be sent to the target model together with the user's input request, and the target model may perform language processing on the input request based on the model prompt information. This may allow the target model to obtain feedback results corresponding to the user's points of interest in the direction of the requested result of the input request based on at least the user's points of interest prompted by the first prompt information when performing language processing on the input request, thereby enabling the user to obtain satisfactory customized results, improving the customization degree of the model output data, and improving the processing effect of the model.

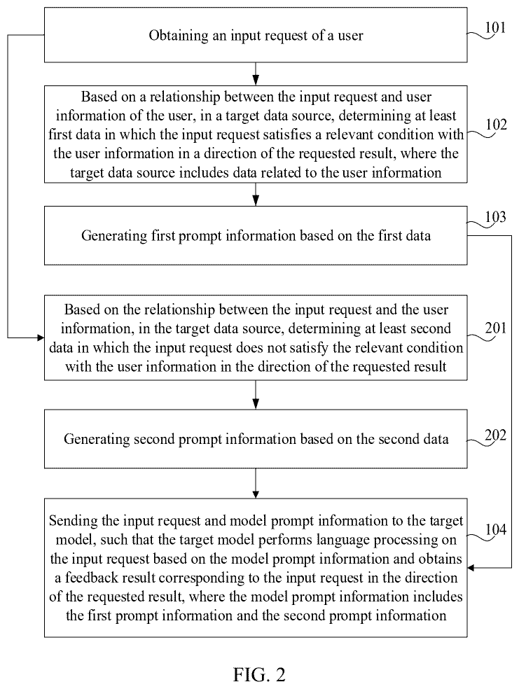

In some embodiments shown in FIG. 2 which is a flowchart of another information processing method provided by the present disclosure, the information processing method may also include S201 and S202.

At S201, based on the relationship between the input request and the user information of the user, at least the second data in the target data source where the input request does not meet the relevant condition with the user information in the direction of the requested result is determined.

In one embodiment, as described above, the relationship between the input request and the user information may be the relationship between the keywords of the input request and the keywords of the user information, for example, may be that there is an overlap or no overlap between the keywords of the input request and the keywords of the user information.

The keywords of the input request and the keywords of the user information may be obtained, and it may be determined whether the keywords of the input request and the keywords of the user information overlap. When there is no overlap, the first index data set may be searched based on the semantic features of the input request, and the search result data may be used as the second data. It is easy to understand that each piece of data in the second data may also include the data information of the corresponding piece of data in the target data source. Still taking each piece of data in the target data source as a document as an example, it may include the corresponding document, or include a series of keywords and/or semantic features respectively contained in the corresponding document.

In one embodiment, the data that meet the semantic similarity condition with the semantic similarity of the input request may be screened out from the first index data set as the search result of the first index data set, that is, as the second data, by determining the semantic similarity between the semantic features contained in each data in the first index data set and the semantic features of the input request.

In one embodiment, optionally, the similarity (semantic similarity) between the semantic features contained in each data in the first index data set and the semantic features of the input request may also be characterized by the distance between the feature vectors of the semantic features contained in each data in the first index data set and the semantic features of the input request (feature vector distance), and the feature vector distance may be inversely correlated with the semantic similarity. When the feature vector distance is larger, the semantic similarity may be lower, and, when the feature vector distance is smaller, the semantic similarity may be higher.

The semantic similarity condition may include, but is not limited to, the distance to the feature vector of the input request is less than the set distance value, or the distance to the feature vector of the input request is the top K in the ascending sequence of distance (feature vector distance). K may be an integer greater than or equal to 1.

At S202, second prompt information is generated based on the second data.

The model prompt information may further include the second prompt information. The first prompt information or the second prompt information in the model prompt information may be empty or non-empty, depending on the actual situation. The prompt method of the first prompt information may be the same as or different from the prompt method of the second prompt information.

When generating the second prompt information based on the second data, whether there is a portion of the second data containing the keywords of user information in the second data. When there is a portion of the second data containing the keywords of user information in the second data, the first sub-prompt information may be generated based on the portion of the second data, and the second sub-prompt information may be generated based on the data other than the portion of the second data in the second data. In this case, the second prompt information may include the first sub-prompt information and the second sub-prompt information.

When there is no portion of the second data containing the keywords of user information in the second data, the third sub-prompt information may be directly generated based on the second data. In this case, the second prompt information may include the third sub-prompt information.

When generating the first sub-prompt information based on the portion of the second data, the portion of the second data may be directly used as the first sub-prompt information, or the portion of the second data may be processed accordingly and the processing result may be used as the first sub-prompt information. For example, the keywords in each piece of data contained in the part of the second data may processed by synonym merging, stop words removal, etc., and the keywords retained after processing may be used as the first sub-prompt information. The generation method of the second sub-prompt information and the third sub-prompt information may be similar to the generation method of the first sub-prompt information, and will not be described in detail.

The prompt method of the first sub-prompt information may be the same as the prompt method of the first prompt information, and the prompt methods of the second sub-prompt information and the third sub-prompt information may be different from the prompt methods of the first prompt information.

The first prompt information may be used as the prompt information of the user's points of interest of the user's input request in the direction of the requested result, and may represent the user's points of interest of the user's input request in the direction of the requested result. Therefore, the first prompt information may play the role of prompting the user's points of interest to the target model, and the prompted points of interest may be the user's points of interest in the direction of the request result of the input request. Correspondingly, the prompt method of the first prompt information may be prompting the target model with the user's points of interest in the direction of the requested result of the input request.

The data based on which the first sub-prompt information is generated may be the part of the second data that contains the keyword of the user information in the second data. Since the part of the second data contains the keywords of the user information, the part of the second data may also be used as the data of the points of interest of the input request in the direction of the requested result in the target data source. The first sub-prompt information generated based on the part of the second data may also be used as the prompt information of the points of interest of the input request in the direction of the requested result, and may characterize the points of interest of the user in the direction of the requested result of the input request. Therefore, the prompting method of the first sub-prompt information may be the same as that of the first prompt information, and the corresponding prompting methods may both be prompting the target model with the points of interest of the user in the direction of in the direction of the requested result of the input request.

The data based on which the second sub-prompt information or the third sub-prompt information is generated may not contain the keywords of user information. Therefore, it may be considered that these data do not fall on the user's points of interest, and may be the data in the target data source where the input request does not fall on the user's points of interest in the direction of the requested result. Therefore, the generated second sub-prompt information or the third sub-prompt information may be used as known data prompt information of the target data source in the direction of the requested result of the input request, to prompt the target model what data other than the user's points of interest the target data source include in the direction of the requested result of the input request (although these data do not fall on the user's points of interest, they may still be data within the data range determined from the user's personal domain/private domain or public domain based on the input request, and therefore have a certain association with the user). Therefore, the prompt methods of the second sub-prompt information or the third sub-prompt information may be different from the prompt method of the first prompt information.

For example, in a personalized question-and-answer scenario, when the target model learns through language processing that there is no answer corresponding to the user's points of interest among the optional answers corresponding to the question input by the user, the answer corresponding to the known data prompt information (the second sub-prompt information or the third sub-prompt information) of the target data source may be selected from the optional answers for output, and the output answer information may still have a certain customization effect for the user. It is easy to understand that, when there is an answer corresponding to the user's points of interest among the optional answers corresponding to the user's input question, the target model may give priority to outputting the answer corresponding to the user's points of interest, that is, the output answer may at least include the answer corresponding to the user's points of interest. In actual applications, the output answers may include both the answer corresponding to the user's points of interest and the answer corresponding to the known data prompt information of the target data source. These answers may reflect a certain customization effect for the user, which may facilitate the user to select a satisfactory customization result from them.

In the present embodiment, based on the relationship between the input request and the user information, at least the second data in the target data source that does not satisfy the relevant condition with the user information in the direction of the requested result of the input request may be determined, and the second prompt information such as the first sub-prompt information/the second sub-prompt information or third sub-prompt information may be generated based on the second data. The generated sub-prompt information may be included in the model prompt information to prompt the target model, such that the target model may not only obtain the user's points of interest, but also obtain data from the target data source other than the user's points of interest in the direction of the requested result of the input request, thereby facilitating the target model to perform more reasonable and comprehensive customized language processing on the input request, further improving the customization degree of the model output data, and improving the processing effect of the model.

In one embodiment, at S201, based on the relationship between the input request and the user information of the user, at least determining the second data in the target data source where the input request does not meet the relevant condition with the user information in the direction of the requested result, may include any one of:
1) when there are overlapping keywords between the keywords of the input request and the keywords of the user information, searching the first index data set based on the semantic features of the input request to obtain second search result data, and determining the second search result data as the second data; or
2) searching the first index data set based on the semantic features of the input request other than the overlapping keywords, and determining the search result data as the second data.

When the keywords of the input request and the keywords of the user information overlap, this embodiment may use any one of the above implementations 1) or 2) to generate the second data.

In the implementation 1), the similarity between the semantic features of the input request and the semantic features respectively contained in each data in the first index data set may be determined, and each data whose similarity with the semantic features of the input request meets the semantic similarity condition may be obtained as the second search result data by searching the first index data set.

The similarity (the semantic similarity) between the semantic features of the input request and the semantic features respectively contained in each data in the first index data set may also be characterized by the distance between the feature vectors of the two semantic features (the feature vector distance). The feature vector distance may be inversely correlated with the semantic similarity.

The above semantic similarity condition may include, but is not limited to, the distance to the feature vector of the input request is less than a set distance value, or the distance to the feature vector of the input request is the top K in the distance (feature vector distance) ascending sequence, where K is an integer greater than or equal to 1.

The semantic similarity conditions involved in different embodiments of the present disclosure may be set to the same condition or different conditions in practical applications. For example, the top X (top K, top N, etc.) in the semantic similarity conditions involved in different embodiments may all use the same value of X and the same distance value (used as the feature vector distance threshold), or different values of X and different distance values.

In the implementation 2), the first index data set may be searched based on the semantic features of the input request other than the overlapping keywords, that is, the semantic features of the request information other than the overlapping keywords in the input request (the overlapping keywords between the input request and the user information) may be used as the search basis to search the first index data set. The search manner in the implementation 2) is the same as the search manner in the implementation 1), and the difference from the implementation 1), is only the difference in the search basis. For details of the search manner, the references may be made to the search manner in the implementation 1), which will not be described in detail here.

When generating the second prompt information based on the second data of this embodiment, whether there is part of the second data containing the keywords of the user information in the second data may be determined first. When there is part of the second data containing the keywords of the user information, the first sub-prompt information may be generated based on the part of the second data, and the second sub-prompt information may be generated based on the data other than the part of the second data in the second data. In this case, the second prompt information may include the first sub-prompt information and the second sub-prompt information.

When there is no part of the second data containing the keywords of the user information in the second data, the third sub-prompt information may be directly generated based on the second data. In this case, the second prompt information may include the third sub-prompt information.

For a more detailed implementation process of generating the first sub-prompt information, the second sub-prompt information or the third sub-prompt information based on the second data, the references may be made to the relevant description of the previous embodiment, which will not be repeated here.

The generated first sub-prompt information may have the same prompt method as the first prompt information, and the second sub-prompt information and the third sub-prompt information may respectively have different prompt methods from the first prompt information.

Subsequently, the generated second prompt information may be included in the model prompt information together with the first prompt information generated above, and the target model may be sent to the target model, to prompt the target model. Based on the model prompt information, the target model may not only obtain the user's points of interest, but also obtain the data of the target data source other than the user's points of interest in the direction of the requested result of the input request, thereby facilitating the target model to perform more reasonable and comprehensive customized language processing on the input request, further improving the customization degree of the model output data, and improving the processing effect of the model.

In some embodiments, when there are overlapping keywords between the keywords of the input request and the keywords of the user information, before sending the input request and the model prompt information to the target model, the information processing method may further include:
performing deduplication processing on the first prompt information and the first sub-prompt information.

Both the first prompt information and the first sub-prompt information may be used as prompt information of the points of interest in the direction of the requested result of the input request, and may characterize the user's points of interest in the direction of the requested result of the input request. Therefore, there may be duplicate data between the first prompt information and the first sub-prompt information, such as duplicate keywords or semantic features. Based on this, when the model prompt information includes both the first prompt information and the first sub-prompt information, in this embodiment, the first prompt information and the first sub-prompt information may be deduplicated before sending the model prompt information to the target model.

In one embodiment, whether there is duplicate data in the first prompt information and the first sub-prompt information may be determined. When there is duplicate data, deduplication processing may be performed and only one of the multiple duplicate data may be retained. The deduplicated prompt information may be included in the model prompt information and sent to the target model, such that the target model performs customized language processing on the input request based on the model prompt information in terms of the prompt points represented by the model prompt information, thereby facilitating the target model to output customized feedback results for the user.

In this embodiment, when the keywords of the input request overlap with the keywords of the user information, the first prompt information and the first sub-prompt information may be deduplicated before sending the input request and the model prompt information to the target model, thereby streamlining the model prompt information, removing redundant data therein, reducing storage costs, and improving the data processing efficiency of the target model.

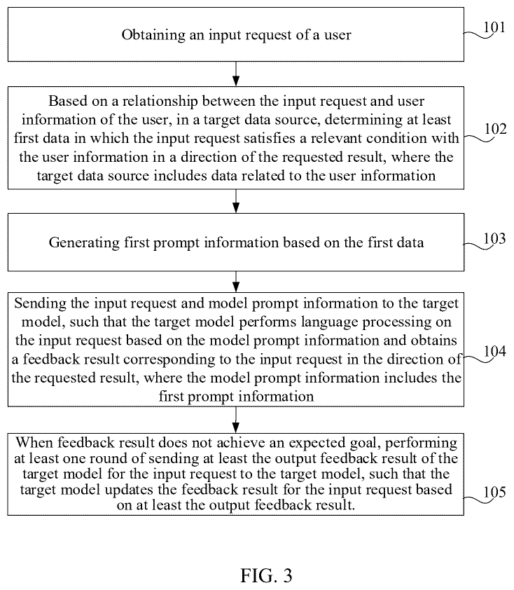

In some embodiment shown in FIG. 3 which is another flowchart of the information processing method provided by the present disclosure, the information processing method further includes:

S105: when the feedback result of the target model does not meet the expected goal, performing at least one round of: at least sending the feedback result output by the target model for the input request to the target model, such that the target model updates the feedback result for the input request based on at least the output feedback result.

The feedback result of the target model that does not meet the expected goal, may include, but is not limited to, that the user still initiates the same input request after the feedback result corresponding to the input request has been provided to the user, or the user gives feedback information representing dissatisfaction to the feedback result of the target model. For example, the user may not be satisfied with the answer information generated by the large language model, and after the model outputs the answer information for the user's question, the user repeatedly asks the model the same question as before, or the user directly gives feedback information indicating dissatisfaction with the answer.

When the feedback result of the target model does not meet the expected goal, one or more rounds of interaction with the target model may continue until the target model outputs a feedback result that satisfies the user for the user's input request. In each round of interaction, the target model's output feedback result for the input request may be used as reference information to trigger the model to execute the processing flow of the input request again, such that the target model uses the output feedback result as a reference and combine the prompts of the model prompt information to perform language processing on the input request, and finally output customized feedback result that may satisfy the user.

The output feedback results of the target model for the input request may include all the output feedback results of the target model for the input request, or part of the output feedback results, without limitation.

In one embodiment, optionally, the user may further point out the aspects that he is dissatisfied with when repeatedly initiating the same input request or providing feedback on the model feedback results. For example, in the repeated questions or feedback on the output answers, the performance or size of the required product may be marked to indicate dissatisfaction with the performance or size. Therefore, when the feedback results do not meet the expected goal and the user continues to interact with the target model for one or more rounds, the output feedback result of the target model for the input request and the indication information provided by the user to represent the dissatisfied aspects may be provided to the target model as reference information to assist the target model in quickly outputting feedback results that satisfy the user.

In the present embodiment, when the feedback results of the target model do not meet the expected goal, interaction with the target model may be performed for one or more rounds, and in each round of interaction, at least the output feedback results of the target model for the input request may be used as reference information, which may assist the target model to quickly obtain a customized feedback result that satisfies the user through further processing when it fails to output a feedback result that satisfies the user for the first time.

An application example of the information processing method provided by the present disclosure will be described below.

In this example, based on the information processing method provided by the present disclosure, the large language model (LLM) may be used to output a customized feedback result for the user's query request.

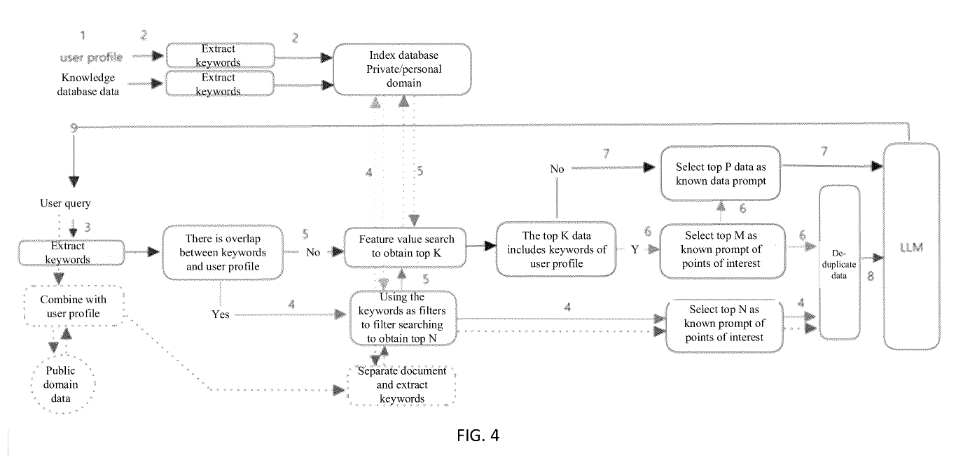

First, the information processing flow when the target data source is the user's personal domain data source (such as a personal domain knowledge base) is introduced. As shown in FIG. 4, the specific processing flow includes:

S1: obtaining user information (user profile) by prompting the user to input and/or obtaining the user information through other channels;

S2: extracting keywords and semantic features from the user information and the user's personal domain data (data in the personal domain knowledge base) to build a personal domain index database;

S3: the user sending the query request, and extracting the keywords and semantic features from the query request data;

S4: when the keywords of the query request and the keywords of the user information have an intersection (i.e., there is an overlap), using the intersection keywords (overlapping keywords) as a filtering condition to search the index database to obtain the top N data that is most similar to the intersection keywords, and using the top N data as the prompt of alternative points of interest (the prompt information of the points of interest);

S5: using the semantic feature value of the query request as a filtering condition, searching the personal domain index database to obtain the top K data, where the semantic feature value of the query request is used as the filtering condition to search the personal domain index database regardless of whether the keywords of the query request and the keywords of the user information have an intersection;

S6: when the keywords of some entries in the top K data obtained in S5 contain the keywords of the user information, selecting the top M data with the highest matching degree with the keywords of the user information in the part of the entries as the prompt of alternative points of interest;

S7: sending the data unrelated to the user information keywords in S4, S5, and S6, to LLM as the knowledge base known data prompt;

S8: deduplicating the prompt of alternative points of interest obtained in S4 and S6, and sending the deduplicated data as the prompt of the points of interest to LLM, where LLM performs language processing on the query request based on the obtained prompt of the points of interest and the knowledge base known data prompt to obtain customized feedback information for the query request; and

S9: when LLM fails to achieve the expected goal, continuing one or more rounds of interaction with LLM, where, in each round of interaction, the feedback results output by LLM may be used as reference data, and LLM's language processing of the query request may be repeated until the output feedback results meet the expected goal, thereby obtaining customized feedback results that better match the user information and satisfy the user.

The processing flow when the target data source is a private domain data source (such as the private domain knowledge base corresponding to the user) may be similar to the processing flow corresponding to the personal domain data source. The only difference may be that the index database is replaced from personal domain data to private domain data, and the model feedback result obtained is related to the private domain data.

For public domain data, as shown in FIG. 4, the query request may be combined with user information as the search condition, and the public domain data may be searched through the search engine, and the search result data (such as each document obtained by the search) may be used as the target data source. And, by performing word segmentation (document segmentation), keyword extraction, semantic feature extraction or other processing on each data in the target data source, the index database corresponding to the target data source may be constructed. On this basis, through a processing flow similar to the above-mentioned personal domain data source, language processing may be performed on the query request based on the model prompt information in the LLM to obtain the customized feedback result corresponding to the query request.

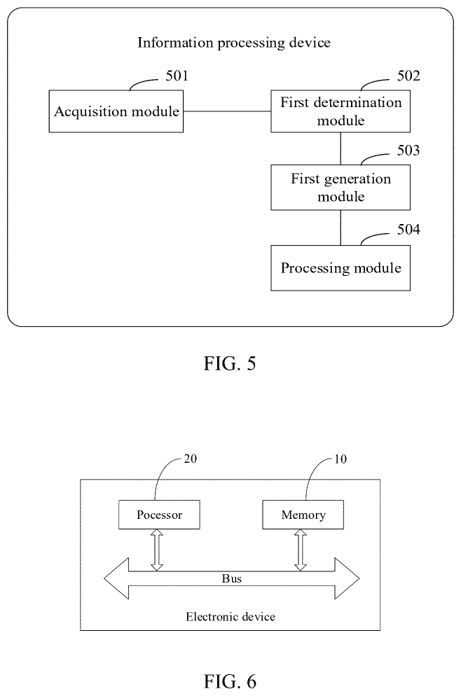

The present disclosure also provides an information processing device. As shown in FIG. 5 which is a structural schematic diagram of an information processing device consistent with the present disclosure, in one embodiment, the information processing device includes an acquisition module 501, a first determination module 502, a first generation module 503, and a processing module 504.

The acquisition module 501 may be used to obtain an input request from a user.

The first determination module 502 may be used to determine, based on the relationship between the input request and the user information of the user, at least the first data in the target data source that satisfies the relevant condition with the user information in the direction of the requested result in the input request. The target data source may include multiple data related to the user information.

The first generation module 503 may be used to generate first prompt information based on the first data.

The processing module 504 may be used to send the input request and model prompt information to a target model, such that the target model performs language processing on the input request based on the model prompt information to obtain a feedback result corresponding to the input request in the direction of the requested result. The model prompt information may include the first prompt information.

In some embodiments, the information processing device may further include a second determination module and a second generation module.

The second determination module may be used to determine, based on the relationship between the input request and the user information, at least second data in the target data source in which the input request does not satisfy the relevant condition with the user information in the requested result direction.

The second generation module may be used to generate second prompt information based on the second data. The model prompt information may also include the second prompt information, and the prompt method of the first prompt information may be the same as or different from the prompt method of the second prompt information.

In one embodiment, the first determination module 502 may be used to:
when the keywords of the input request and the keywords of the user information overlap, search the first index data set based on the overlapping keywords to obtain first search result data, and determine the first search result data as the first data.

The first index data set may be a data set created based on the index data corresponding to each piece of data in the user information and the target data source.

In one embodiment, the second determination module may be configured to:
when the keywords of the input request and the keywords of the user information do not overlap, search the first index data set based on the semantic features of the input request, and use the search result data as the second data

The first index data set may be a data set created based on the index data corresponding to each piece of data in the user information and the target data source.

In one embodiment, the second determination module may be also configured to:
when the keywords of the input request and the keywords of the user information overlap, search the first index data set based on the semantic features of the input request to obtain second search result data, and determine the second search result data as the second data;
or, search the first index data set based on the semantic features of the input request other than the overlapped keywords, and use the search result data as the second data.

In one embodiment, the second generation module may be configured to:
when there is part of the second data containing the keywords of the user information in the second data, generate first sub-prompt information based on the part of the second data, and generate second sub-prompt information based on data other than the part of the second data in the second data; and
when there is no part of the second data containing the keywords of the user information in the second data, generate third sub-prompt information based on the second data.

The second prompt information may include the first sub-prompt information and the second sub-prompt information, or include the third sub-prompt information. The prompt method of the first sub-prompt information may be the same as the prompt method of the first prompt information. The prompt methods of the second sub-prompt information and the third sub-prompt information may be respectively different from the prompt method of the first prompt information.

In one embodiment, the information processing device may further include a deduplication module configured to deduplicate the first prompt information and the first sub-prompt information before sending the input request and the model prompt information to the target model when there are overlapping keywords between the keywords of the input request and the keywords of the user information.

In one embodiment, the target data source may be an existing first data source, or a first data source determined based on a second data source. The second data source may be a public domain data source formed by public domain data, and the first data source may be a non-public domain data source formed by multiple data related to the user information.

In one embodiment, the information processing device may further include a result adjustment module configured to: when the feedback result does not meet the expected goal, perform at least one round of a least sending the output feedback result of the target model for the input request to the target model such that the target model updates the feedback result of the input request based on at least the output feedback result.

The present disclosure also provides an electronic device. As shown in FIG. 6, the electronic device may at least includes:
a memory 10, configured to store a computer instruction set, where the computer instruction set may be implemented as a computer program; and
a processor 20, configured to implement any information processing method provided by various embodiments of the present disclosure through the computer instruction set.

The processor 20 may be a central processing unit (CPU), an application-specific integrated circuit (ASIC), a digital signal processor (DSP), an application-specific integrated circuit (ASIC), a field programmable gate array (FPGA) or another programmable logic device.

The electronic device may include a display device and/or a display interface, or may be connected to an external display device.

The electronic device may also include a camera assembly, and/or may be connected to an external camera assembly.

The electronic device may also include components such as a communication interface or a communication bus. The memory, the processor and the communication interface may communicate with each other through the communication bus.

The communication interface may be used for communication between the electronic device and other devices. The communication bus may be a peripheral component interconnect standard (PCI) bus or an extended industry standard architecture (EISA) bus, etc. The communication bus may be divided into an address bus, a data bus, a control bus, etc.

Embodiment in this specification is described in a progressive manner, and each embodiment focuses on the differences from other embodiments. The same and similar parts between the embodiments can be referred to each other.

For the convenience of description, the above system or device is described by function and is divided into various modules or units and described separately. Of course, when implementing the present disclosure, the functions of each unit can be implemented in the same or one or more software and/or hardware.

It can be seen from the description of the above implementation mode that a person skilled in the art can clearly understand that the present disclosure can be implemented by means of software plus a necessary general hardware platform. Based on such an understanding, the technical solution of this application can be essentially or the part that makes a creative contribution can be embodied in the form of a software product, and the computer software product can be stored in a storage medium, such as ROM/RAM, a disk, an optical disk, etc., including a number of instructions to enable a computer device (which can be a personal computer, a server, or a network device, etc.) to execute the methods described in each embodiment of this application or some parts of the embodiments.

Units and algorithm steps of the examples described in conjunction with the embodiments disclosed herein may be implemented by electronic hardware, computer software or a combination of the two. To clearly illustrate the possible interchangeability between the hardware and software, in the above description, the composition and steps of each example have been generally described according to their functions. Whether these functions are executed by hardware or software depends on the specific application and design constraints of the technical solution. Those skilled in the art may use different methods to implement the described functions for each specific application, but such implementation should not be regarded as exceeding the scope of the present disclosure.

In the present disclosure, the drawings and descriptions of the embodiments are illustrative and not restrictive. The same drawing reference numerals identify the same structures throughout the description of the embodiments. In addition, figures may exaggerate the thickness of some layers, films, screens, areas, etc., for purposes of understanding and ease of description. It will also be understood that when an element such as a layer, film, region or substrate is referred to as being “on” another element, it may be directly on the other element or intervening elements may be present. In addition, “on” refers to positioning an element on or below another element, but does not essentially mean positioning on the upper side of another element according to the direction of gravity.

The orientation or positional relationship indicated by the terms “upper,” “lower,” “top,” “bottom,” “inner,” “outer,” etc. are based on the orientation or positional relationship shown in the drawings, and are only for the convenience of describing the present disclosure, rather than indicating or implying that the device or element referred to must have a specific orientation, be constructed and operated in a specific orientation, and therefore cannot be construed as a limitation of the present disclosure. When a component is said to be “connected” to another component, it may be directly connected to the other component or there may be an intermediate component present at the same time.

In this disclosure, relational terms such as “first” and “second” are only used to distinguish one entity or operation from another entity or operation, and do not necessarily require or imply that there is such actual relationship or sequence between these entities or operations them. Furthermore, the terms “comprises,” “includes,” or any other variation thereof are intended to cover a non-exclusive inclusion, such that an article or device including a list of elements includes not only those elements, but also other elements not expressly listed. Or it also includes elements inherent to the article or equipment. Without further limitation, an element associated with the statement “comprises a . . . ” does not exclude the presence of other identical elements in an article or device that includes the above-mentioned element.

The disclosed equipment and methods may be implemented in other ways. The device embodiments described above are only illustrative. For example, the division of the units is only a logical function division. In actual implementation, there may be other division methods, such as: a plurality of units or components may be combined, or may be integrated into another system, or some features may be ignored, or not implemented. In addition, the coupling, direct coupling, or communication connection between the components shown or discussed may be through some interfaces, and the indirect coupling or communication connection of the devices or units may be electrical, mechanical, or other forms.

The units described above as separate components may or may not be physically separated. The components shown as units may or may not be physical units. They may be located in one place or distributed to a plurality of network units. Some or all of the units may be selected according to actual needs to achieve the purpose of the solution of the present disclosure.

In addition, all functional units in the embodiments of the present disclosure may be integrated into one processing unit, or each unit may be separately used as a unit, or two or more units may be integrated into one unit. The above-mentioned integration units may be implemented in the form of hardware or in the form of hardware plus software functional units.

All or part of the steps to implement the above method embodiments may be completed by hardware related to program instructions. The aforementioned program may be stored in a computer-readable storage medium. When the program is executed, the steps including the above method embodiments may be executed. The aforementioned storage media may include: removable storage devices, ROMs, magnetic disks, optical disks or other media that may store program codes.

When the integrated units mentioned above in the present disclosure are implemented in the form of software function modules and sold or used as independent products, they may also be stored in a computer-readable storage medium. Based on this understanding, the technical solutions of the embodiments of the present disclosure in essence or those that contribute to the existing technology may be embodied in the form of software products. The computer software products may be stored in a storage medium and include a number of instructions for instructing the product to perform all or part of the methods described in various embodiments of the present disclosure. The aforementioned storage media may include: random access memory (RAM), read-only memory (ROM), electrical-programmable ROM, electrically erasable programmable ROM, register, hard disk, mobile storage device, CD-ROM, magnetic disks, optical disks, or other media that may store program codes.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. An information processing method comprising:
obtaining an input request of a user;
based on a relationship between the input request and user information of the user, determining, from a target data source, at least first data in which the input request satisfies a relevant condition with the user information in a direction of the requested result, wherein the target data source includes data related to the user information;
generating first prompt information based on the first data; and
sending the input request and model prompt information to a target model, wherein the target model performs language processing on the input request based on the model prompt information and obtains a feedback result corresponding to the input request in the direction of the requested result, wherein the model prompt information includes the first prompt information.

2. The method according to claim 1, further including:
based on the relationship between the input request and the user information, determining, from the target data source, at least second data in which the input request does not satisfy the relevant condition with the user information in the direction of the requested result; and
generating second prompt information based on the second data, wherein the model prompt information also includes the second prompt information, and a prompt method of the first prompt information is same as or different from a prompt method of the second prompt information.

3. The method according to claim 2, wherein determining at least the first data includes:
when keywords of the input request overlap with keywords of the user information, searching a first index data set based on the overlapping keywords to obtain first search result data, and determining the first search result data as the first data, wherein the first index data set is a data set created based on index data corresponding to each piece of data in the user information and the target data source.

4. The method according to claim 2, wherein determining at least the second data includes:
when there are no overlapping keywords between keywords of the input request and keywords of the user information, searching a first index data set based on semantic features of the input request, and determining search result data as the second data, wherein the first index data set is a data set created based on index data corresponding to each piece of data in the user information and the target data source.

5. The method according to claim 3, wherein determining at least the second data includes:
when there are overlapping keywords between the keywords of the input request and the keywords of the user information, searching the first index data set based on semantic features of the input request to obtain second search result data, and determining the second search result data as the second data; or
searching the first index data set based on semantic features of the input request other than the overlapping keywords, and determining search result data as the second data.

6. The method according to claim 4, wherein generating the second prompt information
based on the second data includes:
when there is a portion of the second data containing the keywords of the user information in the second data, generating first sub-prompt information based on the portion of the partial second data, and generating second sub-prompt information based on data other than the portion of the second data in the second data; and
when there is no portion of the second data containing the keywords of the user information in the second data, generating third sub-prompt information based on the second data,
wherein:
the second prompt information includes the first sub-prompt information and the second sub-prompt information, or includes the third sub-prompt information;
a prompt method of the first sub-prompt information is the same as the prompt method of the first prompt information; and
prompt methods of the second sub-prompt information and the third sub-prompt information are respectively different from the prompt method of the first prompt information.

7. The method according to claim 6, when the keywords of the input request and the keywords of the user information have overlapping keywords, further including:
before sending the input request and the model prompt information to the target model, deduplicating the first prompt information and the first sub-prompt information.

8. The method according to claim 1, wherein:
the target data source is an existing first data source, or a first data source determined based on a second data source; and
the second data source is a public domain data source formed by public domain data, and the first data source is a non-public domain data source formed by multiple data related to the user information.

9. The method according to claim 1, further including:
when feedback result does not achieve an expected goal, performing at least one round of:
sending at least the output feedback result of the target model for the input request to the target model, such that the target model updates the feedback result for the input request based on at least the output feedback result.

10. An electronic device, comprising:
one or more processors, and a memory containing a computer program that, when being executed, causes the one or more processors to perform:
obtaining an input request of a user;
based on a relationship between the input request and user information of the user, determining, from a target data source, at least first data in which the input request satisfies a relevant condition with the user information in a direction of the requested result, wherein the target data source includes data related to the user information;
generating first prompt information based on the first data; and
sending the input request and model prompt information to a target model, wherein the target model performs language processing on the input request based on the model prompt information and obtains a feedback result corresponding to the input request in the direction of the requested result, wherein the model prompt information includes the first prompt information.

11. The device according to claim 10, wherein the one or more processors are configured to preform:
based on the relationship between the input request and the user information, determining, from the target data source, at least second data in which the input request does not satisfy the relevant condition with the user information in the direction of the requested result; and
generating second prompt information based on the second data, wherein the model prompt information also includes the second prompt information, and a prompt method of the first prompt information is same as or different from a prompt method of the second prompt information.

12. The device according to claim 11, wherein the one or more processors are configured to preform:
when keywords of the input request overlap with keywords of the user information, searching a first index data set based on the overlapping keywords to obtain first search result data, and determining the first search result data as the first data, wherein the first index data set is a data set created based on index data corresponding to each piece of data in the user information and the target data source.

13. The device according to claim 11, wherein the one or more processors are configured to preform:
when there are no overlapping keywords between keywords of the input request and keywords of the user information, searching a first index data set based on semantic features of the input request, and determining search result data as the second data, wherein the first index data set is a data set created based on index data corresponding to each piece of data in the user information and the target data source.

14. The device according to claim 12, wherein the one or more processors are configured to preform:
when there are overlapping keywords between the keywords of the input request and the keywords of the user information, searching the first index data set based on semantic features of the input request to obtain second search result data, and determining the second search result data as the second data; or
searching the first index data set based on semantic features of the input request other than the overlapping keywords, and determining search result data as the second data;

15. The device according to claim 13, wherein the one or more processors are configured to preform:
when there is a portion of the second data containing the keywords of the user information in the second data, generating first sub-prompt information based on the portion of the partial second data, and generating second sub-prompt information based on data other than the portion of the second data in the second data; and
when there is no portion of the second data containing the keywords of the user information in the second data, generating third sub-prompt information based on the second data,
wherein:
the second prompt information includes the first sub-prompt information and the second sub-prompt information, or includes the third sub-prompt information;
a prompt method of the first sub-prompt information is the same as the prompt method of the first prompt information; and
prompt methods of the second sub-prompt information and the third sub-prompt information are respectively different from the prompt method of the first prompt information.

16. The device according to claim 15, wherein, when the keywords of the input request and the keywords of the user information have overlapping keywords, the one or more processors are configured to preform:
before sending the input request and the model prompt information to the target model, deduplicating the first prompt information and the first sub-prompt information.

17. The device according to claim 10, wherein:
the target data source is an existing first data source, or a first data source determined based on a second data source; and
the second data source is a public domain data source formed by public domain data, and the first data source is a non-public domain data source formed by multiple data related to the user information.

18. The device according to claim 10, wherein the one or more processors are configured to preform:
when feedback result does not achieve an expected goal, performing at least one round of:
sending at least the output feedback result of the target model for the input request to the target model, such that the target model updates the feedback result for the input request based on at least the output feedback result.

19. A non-transitory computer readable storage medium containing a computer program that, when being executed, causes at least one processor to perform:
obtaining an input request of a user;
based on a relationship between the input request and user information of the user, determining, from a target data source, at least first data in which the input request satisfies a relevant condition with the user information in a direction of the requested result, wherein the target data source includes data related to the user information;
generating first prompt information based on the first data; and
sending the input request and model prompt information to a target model, wherein the target model performs language processing on the input request based on the model prompt information and obtains a feedback result corresponding to the input request in the direction of the requested result, wherein the model prompt information includes the first prompt information.

20. The storage medium according to claim 19, wherein the at least one processor is further configured to preform:
based on the relationship between the input request and the user information, determining, from the target data source, at least second data in which the input request does not satisfy the relevant condition with the user information in the direction of the requested result; and
generating second prompt information based on the second data, wherein the model prompt information also includes the second prompt information, and a prompt method of the first prompt information is same as or different from a prompt method of the second prompt information.
